(19) United States
(12) Patent Application Publication
(10) Pub. No.: US 2021/0075031 A1
(43) Pub. Date: Mar. 11, 2021

(54) FLOW FIELD PLATE FOR ELECTROCHEMICAL FUEL CELLS

(71) Applicant: Ballard Power Systems Inc., Burnaby (CA)

(72) Inventors: Adel Benhaj JILANI, North Vancouver, BC (CA); Radu P. BRADEAN, Burnaby, BC (CA)

(21) Appl. No.: 16/642,330

(22) PCT Filed: Aug. 23, 2018
(86) PCT No.: PCT/US2018/047822

§ 371 Date: Feb. 26, 2020

Related U.S. Application Data
(60) Provisional application No. 62/551,109, filed on Aug. 28, 2017.

(51) Int. Cl. H01M 8/0258; H01M 8/0247; H01M 8/0232; H01M 8/0234

(52) U.S. Cl. CPC H01M 8/0258; H01M 8/0234; H01M 8/0232; H01M 8/0247

(57) ABSTRACT

A flow field plate comprises a first flow field surface, an opposing second surface, and at least one flow channel and at least one landing formed in the first flow field surface, wherein the landing comprises a main surface, at least a first protrusion and a second protrusion extending from the main surface, each of the first and the second protrusions being placed at an edge of the main surface of the landing. The main surface of the landing has preferably a curved shape and the protrusions extending from the main surface have preferably a rounded shape.

### BACKGROUND

### Technical Field

The present disclosure relates to electrochemical fuel cells and, in particular, to a novel design of the flow field plate landings.

### Description of the Related Art

Fuel cell systems convert reactants, namely fuel and oxidant, to electricity and are therefore used as power supplies in numerous applications, such as automobiles and stationary power plants. Such systems are a good solution for economically delivering power with environmental benefits.

Fuel cells generally employ an electrolyte disposed between two electrodes, namely a cathode and an anode. A catalyst typically induces the electrochemical reactions at the electrodes. Preferred fuel cell types include solid polymer electrolyte fuel cells that comprise a solid polymer electrolyte, for example a proton exchange membrane, and operate at relatively low temperatures. Proton exchange membrane fuel cells employ a membrane electrode assembly (“MEA”) having a proton exchange membrane (“PEM”) (also known as an ion-exchange membrane) interposed between an anode electrode and a cathode electrode. The anode electrode typically includes a catalyst and an ionomer, or a mixture of a catalyst, an ionomer and a binder. The presence of ionomer in the catalyst layer effectively increases the electrochemically active surface area of the catalyst, which requires an ionically conductive pathway to the cathode catalyst to generate electric current. The cathode electrode may similarly include a catalyst and a binder and/or an ionomer. Typically, the catalysts used in the anode and the cathode are platinum or platinum alloy. Each electrode generally includes a microporous, electrically conductive substrate, such as carbon fiber paper or carbon cloth, which provides mechanical support to the membrane and is employed for reactant distribution, thus serving as a gas diffusion layer (GDL).

The membrane electrode assembly is typically disposed between two electrically conductive flow field plates or separator plates and thereby forms a fuel cell. These flow field plates act as current collectors, provide support for the electrodes, and provide flow fields for the supply of reactants, such as fuel and oxidant, and removal of excess reactants and products that are formed during operation, such as product water. The flow fields comprise fluid distribution channels separated by landings which contact the electrodes of the MEA when assembled into a fuel cell. The landings act as mechanical supports for the gas diffusion layers and provide electrical contact thereto. A fuel cell stack comprises several fuel cells compressed between endplates.

In an effort to reduce the dimensions of the fuel cell stacks and to reduce the costs associated with the manufacturing of fuel cells while improving fuel cell performance, there is a trend to reduce the thickness of the flow field plates and/or to reduce the thickness of the membrane electrode assemblies by employing thinner, more porous materials for the gas diffusion layers (GDLs).

Reducing the thickness of the flow field plates might involve reducing the depth of the flow field channels which might require increasing the width of the flow field channels to ensure an adequate flow of reactants through the channels. This, in combination with the trend of employing thinner or more porous gas diffusion layers which are less stiff, might trigger the need to provide more support to the GDL material in order to prevent the material from deflecting into the flow field channels under compressive load and to ensure an appropriate contact pressure between the GDL and the membrane. If the deflection of the diffusion layer material is not prevented, channels become obstructed, thus impairing the distribution of reactants and/or removal of reaction products and adversely affecting fuel cell performance. Also, as discussed in “Characterisation of mechanical behavior and coupled electrical properties of polymer electrolyte membrane fuel cell gas diffusion layers” by J. Kleemann, F. Finsterwalder and W. Tillmetz (Journal of Power Sources 190 (2009) pg. 92-102) a minimum contact pressure between the GDL and the membrane in the area corresponding to the channel center is regarded as critical in terms of electrical losses within the fuel cell.

The problem of the gas diffusion layers intrusion into the flow field channels and maintaining an adequate contact pressure between the catalyst coated membrane (CCM) and the gas diffusion layers has been generally addressed by controlling the size (width) of the landings in the flow field plate and respectively the size of the flow channels. Simply increasing the landing area and/or the number of landings in a flow field design or decreasing the width of the flow channels may improve the mechanical support of the adjacent fluid diffusion layers but it also adversely affects fluid access to and from the fluid diffusion layer.

The problem of the intrusion of gas diffusion layers into the flow field channels is addressed for example in the U.S. Pat. No. 6,007,933 which describes the use of support members such as meshes or expanded metals to provide enhanced stability to the diffusion layers. A first side of a support member abuts the flow field plate face, and a second side of the support member abuts the resilient gas diffusion layer. The support member is formed with a plurality of openings. Because of the additional support member placed between the flow field plate and the gas diffusion layer, the resilient gas diffusion layer is restrained against entering the open-faced flow channels of the flow field plate under the compressive force applied to the fuel cell assembly. However, this approach involves using additional components which increase the cell thickness, its complexity and cost.

In another example, U.S. Pat. No. 6,541,145 describes a flow field design for a flow field plate comprising fluid flow channels having an average width W and separated by landings, the fluid flow channels being configured such that unsupported rectangular surfaces of the fluid diffusion layer have a length L and a width W with the ratio L/W being less than about 3. This approach solves the problem of improving the mechanical support for weak fluid diffusion layers, but involves a more complex configuration of the fluid flow field and does not address the problem of maintaining the contact pressure between the membrane and the electrodes.

Accordingly, there still remains a need for solving the problem of the gas diffusion layers intrusion into the flow field channels while ensuring an adequate contact pressure between the CCM and the gas diffusion layers. Embodiments of the present invention address this perceived need and provide further related advantages.

### BRIEF SUMMARY

Briefly summarized, a flow field plate for an electrochemical fuel cell comprises a first flow field surface, an opposing second surface, at least one flow channel formed in the first flow field surface and at least one landing formed in the first flow field surface adjacent to the flow channel, wherein the landing comprises a main surface, a first protrusion extending from the main surface at a first edge thereof and a second protrusion extending from the main surface at the second edge thereof.

In particularly advantageous embodiments, the main surface of at least one of the landings of the first flow field surface has a curved shape. In some other embodiments, the main surface of at least one landing of the first flow field surface has a flat shape.

In particularly advantageous embodiments, the first protrusion extending from the main surface of the landing has a rounded shape with a predetermined radius of curvature. In some embodiments both protrusions extending from the main surface of the landing have a rounded shape with the first protrusion having a first predetermined radius of curvature and the second protrusion having a second predetermined radius of curvature. The first radius of the first protrusion is preferably equal to the second radius of the second protrusion.

In some other embodiments, the first protrusion extending from the main surface of at least one landing of the first flow field surface has a rounded shape and the second protrusion extending from the main surface of that landing has a flat shape. Alternatively both the first and the second protrusions extending from the main surface of at least one landing of the first flow field surface have a flat shape.

Furthermore, is some embodiments, at least one landing of the first flow field surface or each landing of the first flow field surface comprise at least one third protrusion extending from its main surface located between the first and the second protrusions. In some embodiments this third protrusion has a flat shape and in some other embodiments it can have a rounded shape. This third protrusion extending from the main surface of a landing can have the same size and shape as the first and the second protrusions extending from the main surface of the landing at its edges or it can have a different size and/or shape.

The flow field plate according to embodiments of the present invention can comprise a graphitic, carbonaceous or metallic material, or combinations thereof.

In some embodiments, the opposing second surface of the flow field plate is also provided with flow channels separated by landings, with at least one landing comprising a main surface, a first protrusion extending from the main surface at a first edge thereof and a second protrusion extending from the main surface at a second edge thereof.

The main surface of at least one landing on the opposing second surface of the flow field plate can have a curved or a flat shape and the first and the second protrusions on that landing can each have a rounded or a flat shape. The main surface of at least one landing on the opposing second surface of the flow field plate can further comprise at least one third protrusion between the first and the second protrusions, the third protrusion having a flat or a rounded shape. The third protrusion of each landing can have the same size and shape as the first or the second protrusion which extend from the main surface of that landing.

An electrochemical fuel cell is further disclosed, the fuel cell comprising:
a membrane electrode assembly comprising an anode, a cathode, and a proton exchange membrane interposed there between; and
a flow field plate contacting the anode or the cathode comprising:
   a first flow field surface;
   an opposing second surface;
   at least one flow channel formed in the first flow field surface; and
   at least one landing formed in the first flow field surface adjacent to the flow channel,
wherein the landing comprises a main surface, a first protrusion extending from the main surface at a first edge thereof and a second protrusion extending from the main surface at a second edge thereof.

The main surface of the landing can have a curved or a flat shape. The first or the second protrusion extending from the landing can have a rounded or a flat shape. In some embodiments, the first and the second protrusion can have the same shape and size.

In some embodiments, the main surface of the landing can further comprises at least one third protrusion between extending therefrom between the first and the second protrusions.

These and other aspects of embodiments of the invention will be evident upon reference to the following detailed description and attached drawings.

### DESCRIPTION OF THE DRAWINGS

FIG. 1 shows a cross-sectional view of a unit cell configuration according to the prior art.

FIG. 2 shows a cross-sectional view of a unit cell configuration according to a particularly advantageous embodiment of the present invention.

FIG. 3A shows a cross-sectional view of flow field plate according to the embodiment illustrated in FIG. 2.

FIGS. 3B, 3C and 3D show some other possible flow field plate configurations with different landing designs according to the alternative embodiments of the present invention.

FIG. 4 shows the modelling results for the contact pressure between the CCM and the GDL along half of one landing and half of one neighbouring channel of a flow field plate having the configuration according to a particularly advantageous embodiment of the present invention.

FIG. 5 shows the modelling results for the transverse displacement of the GDL along half of one landing and half of one neighbouring channel of a flow field plate having the configuration according to a particularly advantageous embodiment of the present invention.

### DETAILED DESCRIPTION

In the following description, certain specific details are set forth in order to provide a thorough understanding of the various embodiments. However, one skilled in the art will understand that embodiments of the invention may be practiced without these details. In other instances, well-known structures associated with fuel cells, fuel cell stacks, and fuel cell systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to”. Also, reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

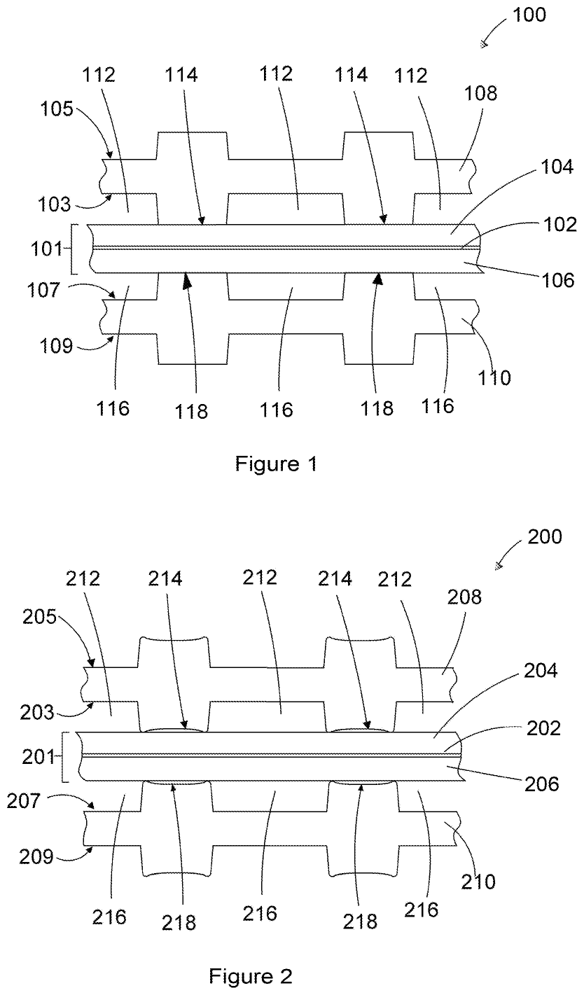

FIG. 1 shows a cross-sectional view of a unit cell 100 from the prior art. MEA 101 comprises a catalyst coated membrane (CCM) 102, an anode gas diffusion layer (GDL) 104, a cathode GDL 106, a first flow field plate 108 next to the anode GDL and a second flow field plate 110 next to the cathode GDL. Flow field plate 108 has a first flow field surface 103 and an opposing surface 105, the first flow field surface 103 being provided with flow channels 112 through which fuel flows, reaching the surface of the anode GDL 104, and with landings 114 which come into contact with the anode GDL 104. In this embodiment, the opposing surface 105 is also a flow field surface provided with flow channels and landings, of a similar construction with flow channels 112 and landings 114, and, within a fuel cell stack, such flow channels and landings come into contact with the cathode of the neighbouring MEA. Flow field plate 110 has a similar construction with flow field plate 108, having a first flow field surface 107 provided with flow channels 116 through which oxidant flows and with landings 118 which come into contact with the cathode GDL 106 and a second flow field surface 109 of a similar construction with first flow field surface 107. Under the compression force exerted by the stack compression system on the flow field plates, landings 114 and 118 ensure the contact between the CCM and the anode and cathode GDLs. The landings 114 and respectively 118 of the flow field plates illustrated in FIG. 1, have a completely flat surface such that the entire surface of the landing sits in contact with the anode and respectively the cathode GDL.

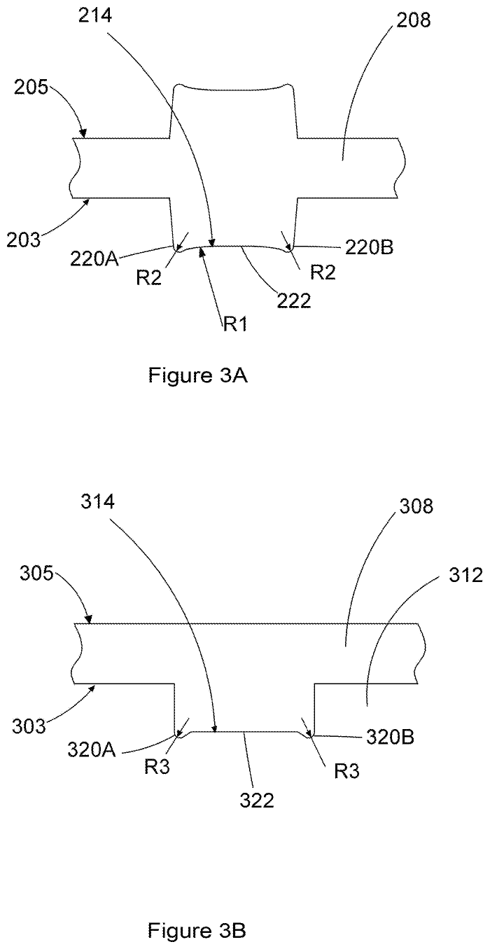

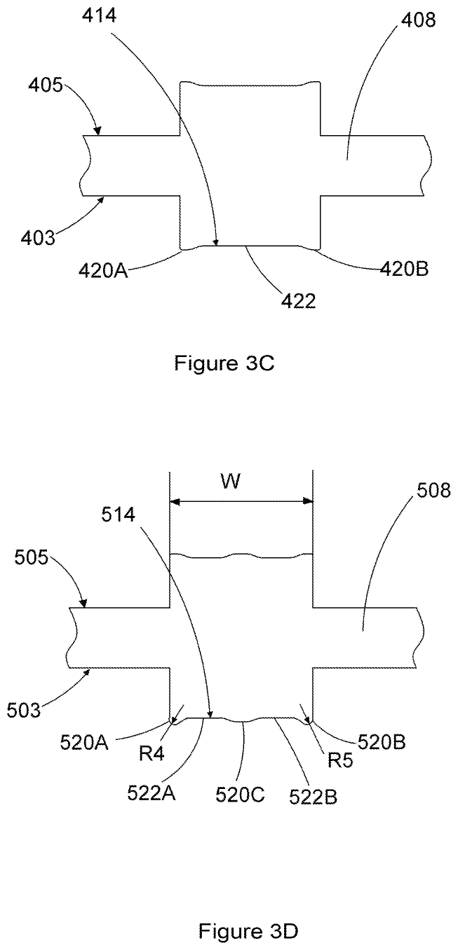

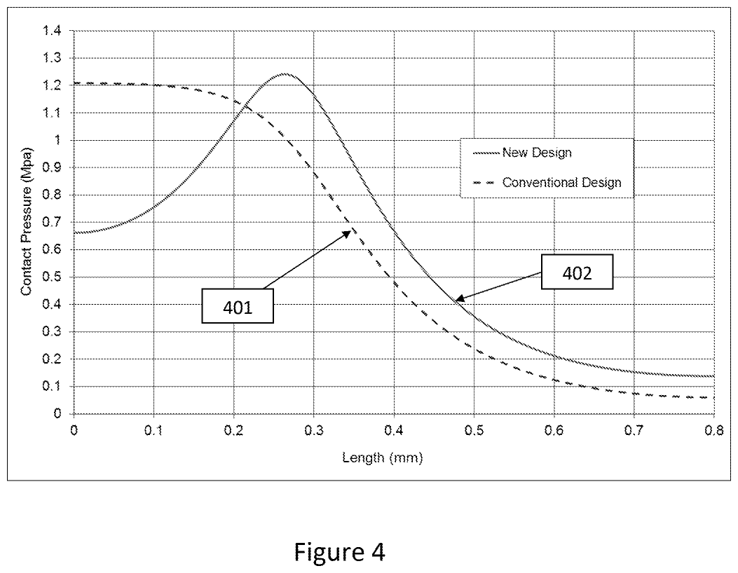

The flow field plate according to a particularly advantageous embodiment of the unit cell described in the present invention is illustrated in FIG. 2. The unit cell 200 comprises the same components as the unit cell 100 of the prior art illustrated in FIG. 1. MEA 201 comprises a catalyst coated membrane (CCM) 202, an anode gas diffusion layer (GDL) 204, a cathode GDL 206, a first flow field plate 208 next to the anode GDL 204 and a second flow field plate 210 next to the cathode GDL 206. The difference between the design of the flow field plates 208 and 210 of the present embodiment and the design of the flow field plates 108 and 110 known in the prior art is that the landings 214 and 218 extending from the first flow field surface 203 of the first flow field plate 208 to the anode GDL 204 and respectively from the first flow surface 207 of the second flow field plate 210 to the cathode GDL 206 are not completely flat, but instead have a curvilinear shape and are provided with protrusions at the edge of the landing, as better illustrated in the enlarged detail view of FIG. 3A. Protrusions 220A and 220B extend from the curvilinear surface 222 of the landing at the edges thereof and such protrusions ensure an increased contact pressure between the CCM 202, the anode GDL 204 and the cathode GDL 206 in the area corresponding to the flow channels 212 and respectively 216 and in particular in the area corresponding to the center of the flow channels, as further illustrated in FIG. 4 and explained below. The curvilinear surface 222 has a radius of curvature R1. The protrusions 220A and 220B have a rounded profile with a radius of curvature R2. In the embodiment illustrated in FIGS. 2 and 3A protrusions 220A and 220B both have a rounded shape of the same radius R2. In other embodiments the radius of protrusion 220A can have a different value than the radius of protrusion 220B. Furthermore, in the embodiment illustrated in FIG. 2 the opposing surface 205 of the flow field plate 208 and respectively the opposing surface 209 of the flow field plate 210 have the same configuration as flow field surface 203 and respectively 207.

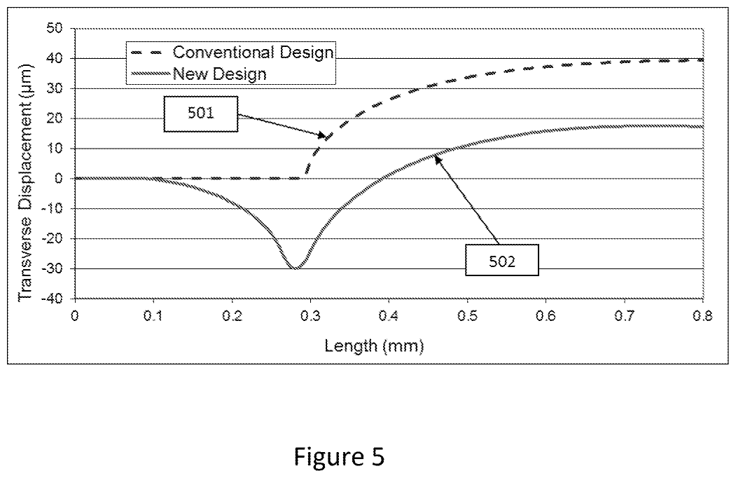

According to the aspects of the present invention, the pressure created on the anode GDL and respectively on the cathode GDL by the protrusions of the flow field plate landings prevents the intrusion of the anode GDL and cathode GDL into the flow field channels. This is illustrated in FIG. 5 and explained further below.

FIG. 3B illustrates another embodiment of a flow field plate according to the present invention. The shape of the landings of flow field plate 308 is different than the one of the landings of the flow field plate shown in FIG. 3A. Landing 314 has a flat surface 322 and is provided with protrusions 320A and 320B which extend from the flat surface 322 at its edges. Protrusions 320A and 320B have a rounded shape having a radius of curvature R3. In the embodiment illustrated in FIG. 3B, flow field plate 308 has a first flow field surface 303 provided with flow channels 312 separated by landings 314 and an opposing surface 305 which is flat and is not provided with channels or landings. This illustrates that in some embodiments the stack of fuel cells comprises flow field plate assemblies separating the membrane electrode assemblies in the stack, with a flow field plate assembly comprising two flow field plates, each flow field plate comprising a first flow field surface provided with flow channels and landings and an opposing flat surface, the plates being placed next to each other with their respective flat surface in contact to each other to form the flow field plate assembly. Such a design feature can be implemented in all the embodiments described here.

FIG. 3C illustrates yet another embodiment of a flow field plate according to the present invention comprising two flow field surfaces 403 and 405. Landing 414 of flow field plate 408 has a flat surface 422 and two protrusions 420A and 420B extending from the flat surface at the edges of the landing as in the previous embodiments. In the present embodiment each of the two protrusions 420A and 420B is in the shape of a flat surface which connects to the flat surface 422 of the landing.

Another embodiment of the present invention refers to a flow field plate 508 having two flow field surfaces 503 and 505 provided with landings which have the shape illustrated in FIG. 3D. Landing 514 comprises two protrusions 520A and 520B at the edge of the landing and a protrusion 520C between the two protrusions 520A and 520B, which is placed, for example, in the center of the landing. Two flat surfaces 522A and 522B connect protrusions 520A, 520C and 520B to form a continuous surface. Protrusions 520A and 520B have a rounded profile having a radius of curvature R4 and respectively R5, while the protrusion 520C at the center of the landing is a flat surface. Radius R4 of the first protrusion can be equal to the radius R5 of the second protrusion or they can have different values.

A person skilled in the relevant art would easily understand that in other embodiments, the flow field plate landings can have more than three protrusions. The number of protrusions depends on the size of the flow field plate landing, with more protrusions being preferably used for landings having a larger width W. In some embodiments, the protrusions at the periphery of the landing can have a flat shape and the protrusion at the center of the landing can have a rounded shape. Any variations in the shape of the protrusions are possible with more or all protrusions having a rounded shape or with more or all protrusions having a flat shape.

The resulting contact pressure at the interface between the CCM and the anode and cathode GDLs for the embodiment illustrated in FIG. 2 and for a flow field plate with a landing width of 0.6 mm, a channel width of 1 mm and a channel depth of 0.27 mm is shown in FIG. 4. The contact pressure between the GDLs and the CCM is measured along the length of the MEA starting at the center of a landing which corresponds to point 0 on the “length” axis, up to the end of the landing which corresponds to point 0.3 on the “length” axis and continuing up to the midpoint of a flow channel neighbouring the landing which corresponds to point 0.8 on the “length” axis) for a fuel cell having a conventional design with flat landings known in the prior art and for a fuel cell according to the present invention. As seen in FIG. 4, the contact pressure at the CCM/GDL interface along the flow field channel (which corresponds to values between 0.3 mm and 0.8 mm on the “length” axis) for the present design of the flow field plate, illustrated by curve 402, is higher than the contact pressure for a flow field plate known in the art, illustrated by curve 401, and it is overall higher than 0.1 MPa which was determined experimentally to be the minimum required contact pressure for the type of GDL and CCM materials used.

Furthermore, the present flow field plate design diminishes the GDL intrusion into the flow field channels as shown by the modelling results illustrated in FIG. 5 which have been conducted for a flow field plate as the one illustrated in FIG. 2 and keeping the same conventions for the points along the “length” axis. FIG. 5 illustrates the transverse displacement of the GDL within the fuel cell relative to a theoretical straight flat position of the GDL on the flow field plate illustrated at the “0” value. As seen in FIG. 5, for the particularly advantageous embodiment of the present invention, the transverse displacement of the GDL (illustrated by curve 502) relative to a flat position of the GDL is decreased relative to the transverse displacement of a GDL in a fuel cell having flow field plates known in the prior art which have flat landings (illustrated by curve 501). For a flow field plate design having a landing width of 0.6 mm and a flow channel width of 1.0 mm, at a landing pressure of 1.6 MPa, the transverse displacement of the GDL into the flow channel decreases, at the center of the flow field channel (illustrated on the length axis at point 0.8 (mm), from around 39 μm for the prior art design to around 17 μm for the current design and the average transverse displacement decreases from around 32 μm for the prior art design to around 8 μm for the current design.

In all the embodiments of the present invention, the illustrated flow field plates can be made of graphite or metal.

Similar to the embodiment illustrated in FIG. 3B, in all the embodiments of the present invention the fuel cell can comprise a flow field plate assembly made of two flow field plates, each flow field plate having a flow field surface provided with landings and flow channels having the construction described in relation to the respective embodiment and an opposing surface which is flat.

In any of the described embodiments some protrusions on the landings of a flow field plate can have a flat surface while others can have a rounded shape. A person skilled in the relevant art would easily understand that the rounded shaped protrusions are preferred over the flat shaped protrusions because they allow a better contact between the GDL and the flow field plate.

In any of the described embodiments, the anode and the cathode catalysts can be deposited on the anode GDL and respectively on the cathode GDL instead of being deposited on the membrane (CCM) to form an MEA.

Embodiments of the present invention have the advantage that allows an increased contact pressure between the GDL and CCM independent of the GDL material (either soft or more rigid) which reduces the contact resistance between them and therefore improves the fuel cell operational performance.

Another advantage is that because the present design of embodiments of the flow field plates demonstrates an improved contact pressure between the GDL and the CCM, the flow channels can be made wider which allows a thinner construction of the flow field plates. Furthermore a smaller compression force is required for compressing the GDL and the CCM.

All the drawings referenced in the present description use the similar numbers for the elements having the same or similar function in the represented embodiments.

From the foregoing, it will be appreciated that, although specific embodiments have been described herein for the purpose of illustration, various modifications may be made without departing from the spirit and scope of the invention. U.S. Provisional Application 62/551,109, filed Aug. 28, 2017, is incorporated herein by reference, in its entirety. Accordingly, the invention is not limited except by the appended claims.

What is claimed is:

1. A flow field plate for an electrochemical fuel cell comprising:
a first flow field surface;
an opposing second surface;
at least one flow channel formed in the first flow field surface; and
at least one landing formed in the first flow field surface adjacent to the flow channel,
wherein the landing comprises a main surface, a first protrusion extending from the main surface at a first edge thereof and a second protrusion extending from the main surface at the second edge thereof.

2. The flow field plate of claim 1, wherein the main surface has a curved shape.

3. The flow field plate of claim 1, wherein the main surface has a flat shape.

4. The flow field plate of claim 1, wherein the first protrusion has a rounded shape with a predetermined radius of curvature.

5. The flow field plate of claim 4, wherein the second protrusion has a flat shape.

6. The flow field plate of claim 1, wherein the first protrusion has a rounded shape with a first radius of curvature and the second protrusion has a rounded shape with a second radius of curvature.

7. The flow field plate of claim 6, wherein the first radius is equal to the second radius.

8. The flow field plate of claim 1, wherein the first protrusion has a flat shape.

9. The flow field plate of claim 1, wherein the first protrusion and the second protrusion have a flat shape.

10. The flow field plate of claim 1 wherein the landing further comprises at least one third protrusion extending from the main surface between the first and the second protrusions.

11. The flow field plate of claim 10, wherein the third protrusion has a flat shape.

12. The flow field plate of claim 10 wherein the third protrusion has a rounded shape.

13. The flow field plate of claim 12 wherein the third protrusion has the same size and shape as the first and the second protrusion.

14. The flow field plate of claim 1, further comprising a graphitic, carbonaceous or metallic material, or combinations thereof.

15. The flow field plate of claim 1 wherein the opposing second surface of the flow field plate is a flow field surface having the at least one landing comprising a main surface, a first protrusion extending from the main surface at a first edge thereof and a second protrusion extending from the main surface at a second edge thereof.

16. The flow field plate of claim 15 wherein the main surface of the opposing second surface of the flow field plate has a curved or a flat shape.

17. The flow field plate of claim 16 wherein the first and the second protrusions, each have a rounded or a flat shape.

18. The flow field plate of claim 15, wherein the landing further comprises at least one third protrusion between the first and the second protrusions, the third protrusion having a flat or a rounded shape.

19. The flow field plate of claim 18, wherein the third protrusion has the same size and shape as the first or the second protrusion.

20. An electrochemical fuel cell, comprising:
a membrane electrode assembly comprising an anode, a cathode, and a proton exchange membrane interposed there between; and
a flow field plate contacting the anode or the cathode comprising:
a first flow field surface;
an opposing second surface;
at least one flow channel formed in the first flow field surface; and
at least one landing formed in the first flow field surface adjacent to the flow channel,
wherein the landing comprises a main surface, a first protrusion extending from the main surface at a first edge thereof and a second protrusion extending from the main surface at a second edge thereof.

21. The electrochemical fuel cell of claim 20 wherein the main surface has a curved or a flat shape.

22. The electrochemical fuel cell of claim 20 wherein first or the second protrusion has a rounded or a flat shape.

23. The electrochemical fuel cell of claim 20 wherein the first and the second protrusions have the same shape and size.

24. The electrochemical fuel cell of claim 20 wherein the main surface further comprises at least one third protrusion between extending therefrom between the first and the second protrusions.
